(19) United States
(12) Patent Application Publication
(10) Pub. No.: US 2026/0053315 A1
(43) Pub. Date: Feb. 26, 2026

(54) CLEANER

(71) Applicant: LG ELECTRONICS INC., Seoul (KR)

(72) Inventors: Inkyu HWANG, Seoul (KR); Kietak HYUN, Seoul (KR); Junhyung LIM, Seoul (KR)

(73) Assignee: LG ELECTRONICS INC., Seoul (KR)

(21) Appl. No.: 19/099,404

(22) PCT Filed: Oct. 27, 2023
(86) PCT No.: PCT/KR2023/016908

§ 371 Date: Jan. 28, 2025

(30) Foreign Application Priority Data
Oct. 31, 2022 (KR) 10-2022-0142137

(51) Int. Cl. A47L 9/16; B01D 45/16; B04C 5/02; B04C 5/103; B04C 5/185; B04C 9/00

(52) U.S. Cl. CPC A47L 9/1608; A47L 9/1633; A47L 9/165; A47L 9/1658; A47L 9/1683; B01D 45/16; B04C 5/02; B04C 5/103; B04C 5/185; B04C 2009/007

(57) ABSTRACT

The present disclosure relates to a cleaner including a dust separating part configured to separate dust from air sucked through a suction part, and a suction motor configured to provide a flow force to air, and a dust bin configured to accommodate the dust separating part therein and store dust separated by the dust separating part, in which the dust separating part includes at least one cyclone unit configured to separate dust from air by means of a cyclone flow, the cyclone unit has a vane provided inside a cyclone body and configured to guide a flow of air, and a slit into which air is introduced is formed in an outer peripheral surface of the cyclone body, such that a force for sucking air may be increased, and dust separation performance may also be improved.

### TECHNICAL FIELD

The present disclosure relates to a cleaner, and more particularly, to a cleaner capable of separating dust by means of a cyclone flow.

### BACKGROUND ART

A cleaner refers to a device that cleans a target cleaning region by sucking dust or debris or wiping the target cleaning region.

In order to provide driving power for sucking dust, the cleaner includes an impeller, and a motor configured to rotate the impeller. The cleaner generates a suction force by reducing internal pressure by discharging inside air to the outside by operating the motor. The suction force, which is generated in this manner, sucks foreign substances, such as dust, on a cleaning surface together with outside air by means of a suction means, and the outside air and the sucked foreign substances may be removed by a dust collecting device or the like.

Depending on the shape of the cleaner, the cleaners may be classified into a canister cleaner, an upright cleaner, a handy cleaner, a stick cleaner, and the like.

A wireless vacuum cleaner uses a multi-cyclone dust collecting device, which uses a centrifugal force, as the dust collecting device for collecting dust and dirt.

The multi-cyclone dust collecting device includes a primary cyclone part configured to separate and collect dirt and dust from dirt-containing air introduced from the outside, and a plurality of secondary cyclone parts configured to separate fine dust from the air discharged from the primary cyclone part.

Meanwhile, Korean Patent No. KR2080013B discloses a vacuum cleaner having a multi-cyclone part.

The vacuum cleaner has a plurality of inlet ports formed outside a body of the cyclone part. Therefore, a cyclone flow may be generated as air is introduced in a tangential direction of the cyclone part.

However, in the case of the vacuum cleaner, the cyclone flow is generated outside the cyclone part. For this reason, there is a limitation in that a rotational force of air is low and dust separation performance deteriorates in comparison with an axial-flow type cleaner having a vane for inducing a cyclone flow on an inner peripheral surface of the cyclone part.

In addition, because a conical shape of a lower portion of the cyclone part is disposed to be close to a wall surface of a dust bin, there is a limitation in that a rotational airflow may be eliminated as the air flowing along the inside of the cyclone part rubs against the wall surface of the dust bin.

### DISCLOSURE

### Technical Problem

The present disclosure has been made in an effort to solve the above-mentioned problem of the cleaner in the related art, and an object of the present disclosure is to provide a cleaner capable of increasing a force for sucking air, and improving performance in separating dust.

Another object of the present disclosure is to provide a cleaner capable of preventing a rotational airflow generated in a cyclone part from being eliminated while the rotational airflow collects dust.

Still another object of the present disclosure is to provide a cleaner capable of improving dust separation performance by maximizing a length of an inside of a cyclone part in which air flows.

### Technical Solution

In order to achieve the above-mentioned objects, a cleaner according to the present disclosure includes: a suction part having a flow path through which air flows; a dust separating part configured to separate dust from air sucked through the suction part; a suction motor configured to provide a flow force to the air; and a dust bin configured to accommodate the dust separating part therein and store dust separated by the dust separating part, in which the dust separating part includes at least one cyclone unit configured to separate dust from air by means of a cyclone flow, in which the cyclone unit includes: a cyclone body having a cylindrical shape and configured such that air flows in the cyclone body; an air discharge part configured to allow the air, which has passed through the cyclone body, to flow to the suction motor; and a vane disposed between an inner peripheral surface of the cyclone body and an outer peripheral surface of the air discharge part and configured to guide a flow of air, and in which a slit into which air is introduced is formed in an outer peripheral surface of the cyclone body.

In this case, a direction in which the slit is formed may intersect a radial direction of the cyclone body.

The cyclone unit may further include an air inflow guide extending radially outward from the cyclone body and formed in a direction applied to a direction in which the slit is formed.

The vane may be formed to become gradually distant from the suction motor in a direction in which air introduced into the slit flows.

Meanwhile, the dust separating part may include at least one cyclone unit configured to separate dust from air by means of a cyclone flow, the cyclone unit may include: a cyclone body having a cylindrical shape and configured such that air flows in the cyclone body; and a dust discharge part extending from one end of the cyclone body based on a longitudinal direction and configured such that dust separated from air is discharged through the dust discharge part, the dust discharge part may have a diameter that gradually decreases from one end of the cyclone body based on the longitudinal direction, and a length of a generating line on an outer peripheral surface of the dust discharge part may vary.

In particular, a length of the generating line of the dust discharge part may increase as the dust discharge part becomes distant from a center of the dust bin.

In this case, the dust separating part may have a plurality of cyclone units disposed in a circumferential direction about an imaginary line defined by extending a rotation axis of the suction motor.

Further, the plurality of cyclone units may be disposed on at least two or more concentric circles having different radii from a center of the dust separating part, and an overall length of the cyclone unit may increase as the cyclone unit is disposed to be distant from the center of the dust separating part.

In this case, the dust separating part may further include a dust collecting guide part disposed between the cyclone unit and a bottom surface of the dust bin and configured to guide a movement of dust separated by the cyclone unit, the dust may flow along the dust discharge part and then flow along the dust collecting guide part, and an angle defined by an inner peripheral surface of the dust collecting guide part and an inner peripheral surface of the dust discharge part disposed in a flow direction of dust may be 150 degrees or more.

### Advantageous Effects

According to the present disclosure cleaner described above, the slit is formed in the outer peripheral surface of the cyclone part, and the vane is disposed on the inner peripheral surface of the cyclone part, such that both the advantage of the tangential inflow type cyclone part and the advantage of the axial-flow type cyclone part are implemented, which may improve the dust separation performance while increasing the force for sucking air.

In addition, the conical structure at the lower side of the cyclone part is formed to be inclined toward the center of the dust bin, which may prevent the rotational airflow generated in the cyclone part from being eliminated while colliding with the wall surface that guides the movement of the dust.

In addition, the diameter of the dust discharge part at the lower side of the cyclone part may be decreased, and the length of the cone may be increased, such that the length of the inside of the cyclone part in which air flows may be maximized, thereby improving the dust separation performance.

### DESCRIPTION OF DRAWINGS

FIG. 1 is a schematic view of a cleaner according to an embodiment of the present disclosure.

FIG. 2 is a perspective view illustrating a cleaner main body according to the embodiment of the present disclosure.

FIG. 3 is a cross-sectional view for explaining a flow of air in the cleaner according to the embodiment of the present disclosure.

FIG. 4 is a cross-sectional view for explaining a dust separating part of the cleaner according to the embodiment of the present disclosure.

FIG. 5 is a partially cut-away view for explaining a cyclone unit of the cleaner according to the embodiment of the present disclosure.

FIG. 6 is a view illustrating an upper portion of the cyclone unit of the cleaner according to the embodiment of the present disclosure.

FIG. 7 is a view for explaining a state in which a plurality of cyclone units is disposed in the cleaner according to the embodiment of the present disclosure.

FIG. 8 is a partial perspective view for explaining a lower arrangement of the plurality of cyclone units of the cleaner according to the embodiment of the present disclosure.

FIG. 9 is a cross-sectional view for explaining a lower structure of the cyclone unit of the cleaner according to the embodiment of the present disclosure.

FIG. 10A is a view for explaining a situation in which a rotational airflow is eliminated as air flowing in a cyclone unit of a cleaner in the related art rubs against a wall surface of a dust bin.

FIG. 10B is a view for explaining an effect of maintaining a rotational airflow of air in the cyclone unit according to the embodiment of the present disclosure.

FIG. 11 is a partially cut-away view for explaining a cyclone unit of a cleaner according to another embodiment of the present disclosure.

FIG. 12 is a view illustrating an upper portion of the cyclone unit of the cleaner according to another embodiment of the present disclosure.

FIG. 13 is a view for explaining a state in which a plurality of cyclone units is disposed in the cleaner according to another embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

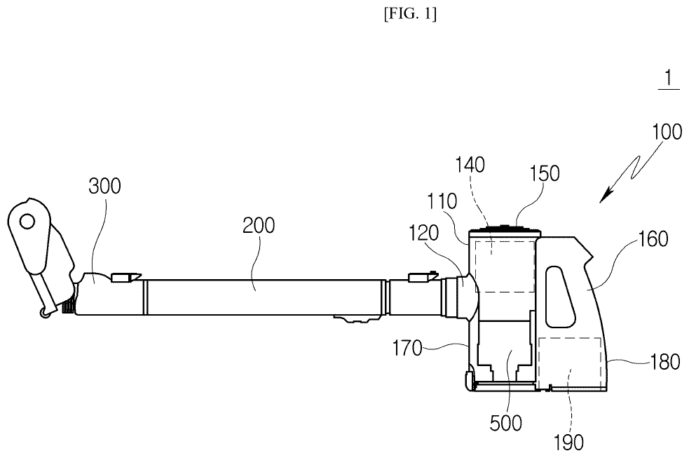

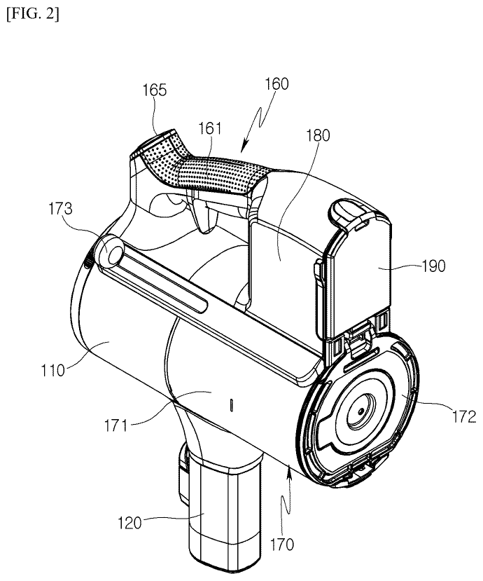

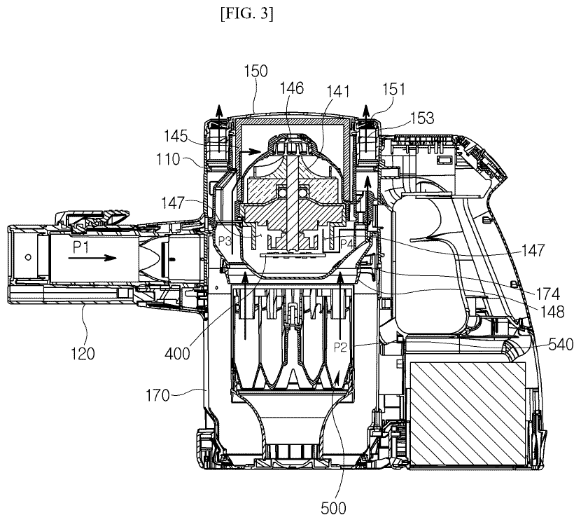

FIG. 1 is a schematic view of a cleaner according to an embodiment of the present disclosure, FIG. 2 is a perspective view illustrating a cleaner main body according to the embodiment of the present disclosure, and FIG. 3 is a cross-sectional view for explaining a flow of air in the cleaner according to the embodiment of the present disclosure.

Meanwhile, the term “floor surface” used in the present specification may mean not only a floor surface of a room such as a living room but also a cleaning surface such as a carpet.

With reference to FIGS. 1 to 3, a cleaner 1 according to an embodiment of the present disclosure may include a cleaner main body 100 having a suction motor 140 configured to generate a suction force, a suction module 300 connected to the cleaner main body 100 and configured to suck air and foreign substances on the floor surface, and an extension tube 200 configured to connect the cleaner main body 100 and the suction module 300.

A structure of the cleaner main body 100 will be described below.

Meanwhile, in the embodiment of the present disclosure, directions may be defined on the basis of when a bottom surface (lower surface) of a dust bin 170 and a bottom surface (lower surface) of a battery housing 180 are placed on the ground surface.

In this case, a forward direction may mean a direction in which a suction part 120 is disposed based on the suction motor 140, and a rearward direction may mean a direction in which a handle 160 is disposed based on the suction motor 140. Further, based on a state in which the suction part 120 is viewed from the suction motor 140, a rightward direction may refer to a direction in which a component is disposed at the right, and a left direction may refer to a direction in which a component is disposed at the left. In addition, in the embodiment of the present disclosure, upper and lower sides may be defined in a direction perpendicular to the ground surface based on the state in which the bottom surface (lower surface) of the dust bin 170 and the bottom surface (lower surface) of the battery housing 180 are placed on the ground surface.

The cleaner 1 may include the cleaner main body 100. A flow path may be formed in the cleaner main body 100 and guide the sucked air so that the air is discharged to the outside.

Specifically, the cleaner main body 100 may include a main body housing 110, the suction part 120, a dust separating part 500, the suction motor 140, an air discharge cover 150, the handle 160, the dust bin 170, the battery housing 180, and a battery 190.

The main body housing 110 may define an external appearance of the cleaner main body 100. The main body housing 110 may provide a space that may accommodate the suction motor 140 and a prefilter 145. For example, the main body housing 110 may be formed in a shape similar to a cylindrical shape.

The suction part 120 may protrude outward from the main body housing 110. For example, the suction part 120 may be formed in a cylindrical shape with an opened inside. The suction part 120 may be coupled to an extension tube 200. The suction part 120 may provide a flow path P1 in which air containing dust may flow.

The dust separating part 500 may communicate with the suction part 120. The dust separating part 500 adopts a principle of a dust collector using a centrifugal force to separate the dust sucked into the cleaner main body 100 through the suction part 120. A space in the dust separating part 500 may communicate with a space in a dust bin 170.

For example, the dust separating part 500 may include at least one cyclone unit 510 capable of separating dust by means of a cyclone flow. Further, the space in the dust separating part 500 may communicate with a flow path P2 formed in the suction part 120. Therefore, air and dust, which are sucked through the suction part 120, spirally flow along an inner circumferential surface of the dust separating part 500. Therefore, the cyclone flow may be generated in an internal space of the dust separating part 500.

The specific configuration and effect of the dust separating part 500 will be described below in detail.

The suction motor 140 may be disposed in the flow path and generate a flow force for moving the air in the flow path.

The suction motor 140 may have an impeller 141. A shaft of the suction motor 140 may be inserted into a center of the impeller 141 in an upward/downward direction. In this case, the shaft of the suction motor 140 may be fixed to the center of the impeller 141. With this configuration, when the suction motor 140 operates, the impeller 141 may rotate together with the shaft of the suction motor 140 and generate the flow force for the air.

For example, the suction motor 140 may include an annular stator, the shaft configured to penetrate the center of the stator, and a rotor axially installed on the shaft and configured to generate a rotational force together with the stator. Meanwhile, in the present embodiment, a brushless direct current motor (BLDC motor) is used as the suction motor 140. However, the present disclosure is not limited thereto. Various types of motors may be applied.

The suction motor 140 may suck air through an air suction port 146 provided in an upper central portion of a housing of the suction motor 140 and discharge the air through an air discharge port 147 provided in a circumferential direction at a lower side of the suction motor 140. With this configuration, the air flowing in the suction motor 140 may effectively dissipate heat from heating elements mounted on a printed circuit board.

The cleaner 1 may include the prefilter 145 configured to filter the air before the air is sucked into the suction motor 140. For example, the prefilter 145 may be disposed to surround the impeller 141. For example, the air in a suction flow path P3 may pass through the prefilter 145 and reach the impeller 141. The prefilter 145 may be disposed in the cleaner main body 100. The prefilter 145 may be disposed below the air discharge cover 150. A user may separate the air discharge cover 150 from the main body housing 110 and withdraw the prefilter 145 from the inside of the cleaner main body 100.

The cleaner main body 100 may include an air guide 148 configured to guide the air discharged from the dust separating part 500. The air guide 148 may be disposed between the main body housing 110 and the housing of the suction motor 140. The air guide 148 may define the suction flow path P3 configured to guide the air from the dust separating part 500 to the impeller 141. The air guide 148 may define an air discharge flow path P4 configured to guide the air, which has passed through the impeller 141, to an air discharge port 151.

With this configuration, the air guide 148 may define the flow paths P3 and P4 so that the air discharged from the dust separating part 500 ascends, descends while passing through the impeller 141, and then ascends again to the air discharge port 151.

Therefore, for example, the air and dust, which are sucked through the flow path Pl in the suction part 120 by the operation of the suction motor 140, may be separated from each other while flowing through the flow path P2 in the dust separating part 500. The air, from which dust is separated by the dust separating part 500, may move upward and be introduced into the suction flow path P3 in a fan driving part. The suction flow path P3 may guide the air toward the prefilter 145. The air sequentially passing through the prefilter 145 and the impeller 141 may be introduced into the air discharge flow path P4 and discharged to the outside through the air discharge port 151 after passing through a HEPA filter 153.

Meanwhile, the cleaner 1 according to the embodiment of the present disclosure may include a printed circuit board (PCB) 400 configured to control the suction motor 140. The printed circuit board 400 may be disposed between the suction motor 140 and the dust separating part 500.

The air discharge cover 150 may define an external appearance of an upper side of the cleaner main body 100 and cover an upper side of the suction motor 140.

The air discharge cover 150 may be disposed at one side of the main body housing 110 based on an axial direction.

The air discharge port 151, through which the air in the flow path is discharged to the outside of the cleaner main body 100, may be formed in the air discharge cover 150.

For example, the air discharge port 151 may be disposed to be directed in a particular direction. For example, the plurality of air discharge ports 151 may be divided in the circumferential direction. The plurality of air discharge ports 151 may be arranged to be spaced apart from one another at predetermined intervals in the circumferential direction.

The air discharge cover 150 may accommodate a filter configured to filter the air before the air is discharged to the air discharge port 151. For example, the air discharge cover 150 may accommodate the HEPA filter 153.

The air having passed through the suction motor 140 may pass through the HEPA filter 153 and then be discharged to the outside through the air discharge port 151. The HEPA filter 153 may be disposed in the air discharge flow path P4.

The air discharge cover 150 may have a filter accommodation space for accommodating the HEPA filter 153. The filter accommodation space may be formed to be opened at a lower side thereof, and the HEPA filter 153 may be accommodated at the lower side of the air discharge cover 150.

The air discharge port 151 may be formed to face the HEPA filter 153. For example, the HEPA filter 153 may be disposed below the air discharge port 151. For example, the HEPA filter 153 may be disposed to extend in the circumferential direction along the air discharge port 151.

The handle 160 may be gripped by the user. The handle 160 may be disposed rearward of the suction motor 140. For example, the handle 160 may be formed in a shape similar to a cylindrical shape. Alternatively, the handle 160 may be formed in a curved cylindrical shape. The handle 160 may be disposed at a predetermined angle with respect to the main body housing 110, the suction motor 140, or the dust separating part 500.

The handle 160 may include a grip portion 161 formed in a column shape so that the user may grasp the grip portion 161, a first extension portion connected to one end of the grip portion 161 based on the longitudinal direction (axial direction) of the grip portion 161 and extending toward the suction motor 140, and a second extension portion connected to the other end of the grip portion 161 based on the longitudinal direction (axial direction) of the grip portion 161 and extending toward the dust bin 170.

An upper side of the handle 160 may define an external appearance of a part of an upper side of the cleaner 1. Therefore, it is possible to prevent a component of the cleaner 1 from coming into contact with the user's arm when the user grips the handle 160.

The operating part 165 may be disposed on the handle 160. The operating part 165 may be disposed on an inclined surface formed in an upper region of the handle 160. The user may input a command for operating or stopping the cleaner 1 through the operating part 165.

The dust bin 170 may be disposed below the main body housing 110. The dust separating part 500 may be accommodated in the dust bin 170. The dust bin 170 may communicate with the dust separating part 500. The dust bin 170 may store the dust separated by the dust separating part 500.

The dust bin 170 may include a dust bin main body 171.

The dust bin main body 171 may provide a space capable of storing the dust separated by the dust separating part 500. For example, the dust bin main body 171 may be formed in a shape similar to a cylindrical shape.

For example, the dust bin main body 171 may be configured such that a lower side of the dust bin main body 171 may be opened. In this case, a discharge cover 172 may be provided at the lower side of the dust bin main body 171 and may be configured to selectively open the lower side of the dust bin main body 171.

The discharge cover 172 may be provided to open or close the lower side of the dust bin main body 171. The discharge cover 172 may be rotatably coupled to the lower side of the dust bin main body 171. The discharge cover 172 may be hingedly coupled to the dust bin main body 171 and open or close a lower side of the dust bin 170 while rotating.

Meanwhile, according to the embodiment, the dust bin 170 may further include a dust bin compression lever 173 and a compression member 174.

The dust bin compression lever 173 may be disposed outside the dust bin 170 or the dust separating part 500. The dust bin compression lever 173 may be disposed outside the dust bin 170 or the dust separating part 500 so as to be movable upward and downward. The dust bin compression lever 173 may be connected to the compression member 174. When the dust bin compression lever 173 is moved downward by external force, the compression member 174 may also be moved downward. Therefore, it is possible to provide convenience for the user. The compression member 174 and the dust bin compression lever 173 may return back to original positions by an elastic member (not illustrated). Specifically, when the external force applied to the dust bin compression lever 173 is eliminated, the elastic member may move the dust bin compression lever 173 and the compression member 174 upward.

The compression member 174 may be disposed in the dust bin main body 171. The compression member 174 may move in the internal space of the dust bin main body 171. Specifically, the compression member 174 may move upward or downward in the dust bin main body 171. Therefore, the compression member may compress downward the dust in the dust bin main body 171. In addition, when the discharge cover 172 is separated from the dust bin main body 171 and thus the lower side of the dust bin 170 is opened, the compression member 174 may move from an upper side of the dust bin 170 to the lower side of the dust bin 170, thereby removing debris such as residual dust in the dust bin 170. Therefore, it is possible to improve the suction force of the cleaner by preventing the residual dust from remaining in the dust bin 170. Further, it is possible to remove an offensive odor caused by the residual dust by preventing the residual dust from remaining in the dust bin 170.

The battery 190 may be accommodated in the battery housing 180. The battery housing 180 may be disposed below the handle 160.

For example, the battery housing 180 may have a hexahedral shape opened at a lower side thereof. A rear side of the battery housing 180 may be connected to the handle 160. In this case, the battery housing 180 may include an accommodation portion opened at a lower side thereof. With this configuration, the battery 190 may be attached or detached through the accommodation portion of the battery housing 180.

As another example, the battery housing 180 and the battery 190 may be integrated in a state in which the battery housing 180 accommodates the battery 190.

The battery 190 serves to supply power to the cleaner 1. Specifically, the battery 190 may supply power to the suction motor 140 and supply power to an electronic circuit and an electronic component through electric wires embedded in the cleaner 1. In addition, the battery 190 may supply power to the suction module 300.

In a case in which the battery 190 is coupled to the battery housing 180, a lower side of the battery 190 may be exposed to the outside. Because the battery 190 may be placed on the floor when the cleaner 1 is placed on the floor, the battery 190 may be immediately separated from the battery housing 180. In addition, because the lower side of the battery 190 is exposed to the outside and thus in direct contact with the air present outside the battery 190, the performance in cooling the battery 190 may be improved.

Meanwhile, in case that the battery 190 is fixed integrally to the battery housing 180, the number of structures for attaching or detaching the battery 190 and the battery housing 180 may be reduced, and as a result, it is possible to reduce an overall size of the cleaner 1 and a weight of the cleaner 1.

Meanwhile, the cleaner 1 may include the extension tube 200.

The extension tube 200 may be coupled to the cleaner main body 100 and the suction module 300. One end of the extension tube 200 may be detachably coupled to the suction part 120. Further, the other end of the extension tube 200 may be detachably coupled to the suction module 300.

For example, the extension tube 200 may be formed in a long cylindrical shape. Therefore, an internal space of the extension tube 200 may communicate with an internal space of the cleaning module 300. In addition, the extension tube 200 may communicate with the suction flow path formed in the suction part 120 of the cleaner main body 100.

When the suction force is generated by the suction motor 140, the suction force may be provided to the suction module 300 through the suction part 120 and the extension tube 200. Therefore, outside dust and air may be introduced into the cleaner main body 100 through the cleaning module 300 and the extension tube 200. In addition, dust and air introduced through the suction module 300 may pass through the extension tube 200 and then be introduced into the cleaner main body 100. Further, the dust and air, which has been introduced into the cleaner main body 100 and has passed through the suction part 120, may be separated from the dust separating part 500, the dust may be stored in the dust bin 170, and the air may be discharged to the outside through the air discharge cover 150.

The suction module 300 may move along the floor surface and suck dust present on the floor surface. The suction module 300 may be connected to the cleaner main body 100 through the extension tube 200.

For example, the suction module 300 may have an agitator capable of guiding dust on the floor surface to the suction port while rotating. Alternatively, a rag (mop) may be further provided on the suction module 300 and configured to wipe the floor surface.

Meanwhile, although not illustrated, the suction module 300 may be connected directly to the cleaner main body 100 even without the extension tube 200.

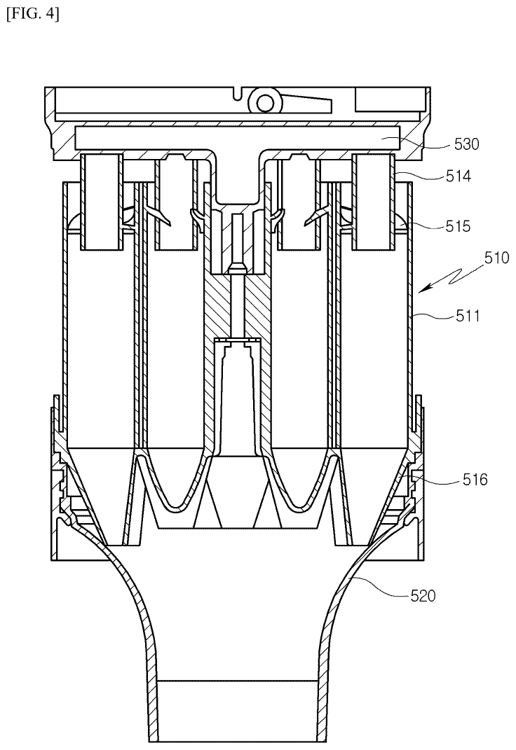

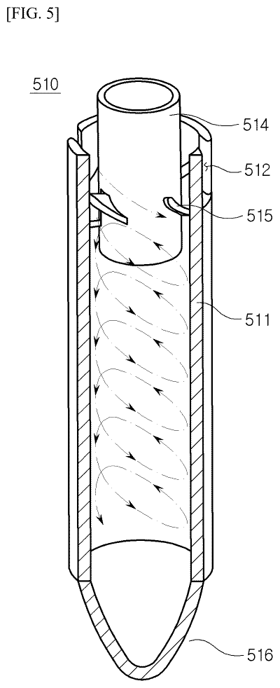

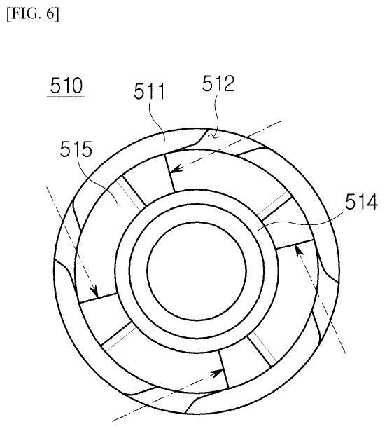

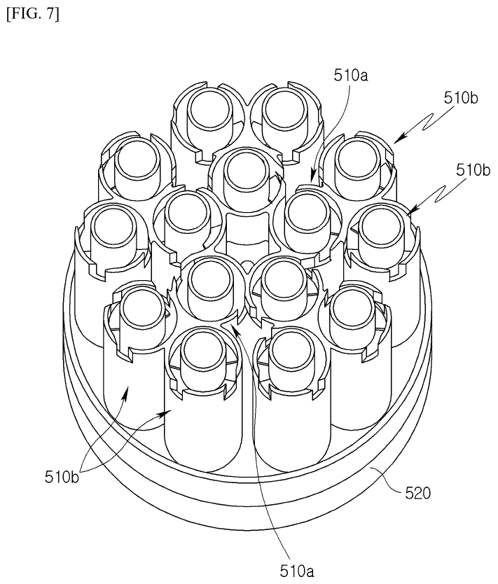

Meanwhile, FIG. 4 is a cross-sectional view for explaining the dust separating part of the cleaner according to the embodiment of the present disclosure, FIG. 5 is a partially cut-away view for explaining a cyclone unit of the cleaner according to the embodiment of the present disclosure, FIG. 6 is a view illustrating an upper portion of the cyclone unit of the cleaner according to the embodiment of the present disclosure, and FIG. 7 is a view for explaining a state in which a plurality of cyclone units is disposed in the cleaner according to the embodiment of the present disclosure.

The dust separating part 500 of the cleaner according to the embodiment of the present disclosure will be described with reference to FIGS. 4 to 7.

The dust separating part 500 includes the cyclone unit 510, a dust collecting guide part 520, a cyclone coupling part 530, and a mesh net 540.

The dust separating part 500 is disposed in the dust bin 170 and disposed in a space that communicates with the flow path of the suction part 120 and the flow path of the suction motor 140 so that air flows in the space. Specifically, the dust separating part 500 may be disposed rearward of the suction part 120 and disposed below the suction motor 140.

In this case, an upper side of the cyclone unit 510 is coupled to the cyclone coupling part 530 and coupled to the suction motor 140, and a lower side of the cyclone unit 510 is coupled to the dust collecting guide part 520. In addition, the cyclone unit 510 may be disposed to be accommodated in the mesh net 540.

At least one cyclone unit 510 may be provided and separate dust from the air by means of the cyclone flow. That is, the air, which is sucked by the suction force of the suction motor 140, may spirally flow along an inner peripheral surface of the cyclone unit 510, such that dust may be separated by a centrifugal force.

The cyclone unit 510 includes a cyclone body 511, a slit 512, an air discharge part 514, vanes 515, and a dust discharge part 516.

The cyclone body 511 may have a space in which air flows. For example, the cyclone body 511 may be formed in a cylindrical shape and provide a flow path in which air may flow.

Meanwhile, the slit 512, into which air is introduced, may be formed in an outer peripheral surface of the cyclone body 511. The slit 512 may be a hole that allows the internal space of the cyclone body 511 to communicate with the outside. In this case, the slit 512 may have a long hole shape formed in a longitudinal direction of the cyclone body 511. A direction in which the slit 512 is formed may intersect a radial direction of the cyclone body 511.

Specifically, the cyclone body 511 may have a predetermined thickness. A sidewall of the slit 512 may be formed while defining an inclined surface with a predetermined angle toward the inner peripheral surface of the cyclone body 511 from the outer peripheral surface of the cyclone body 511. For example, the slit 512 may be formed in a tangential direction of the cylindrical cyclone body 511.

At least one slit 512 may be formed in the circumferential direction of the cyclone body 511. For example, four slits 512 may be formed at intervals of 90 degrees in the circumferential direction of the cyclone body 511. As another example, three slits 512 may be formed at intervals of 120 degrees in the circumferential direction of the cyclone body 511. As still another example, three slits 512 may be formed at intervals of 90 degrees in the circumferential direction of the cyclone body 511. As yet another example, two slits 512 may be formed at an interval of 180 degrees in the circumferential direction of the cyclone body 511.

With this configuration, the air introduced into the cyclone body 511 may generate a spiral flow (cyclone flow) while being introduced in the tangential direction of the cyclone body 511.

In addition, in the present disclosure, the slit 512 is formed to expand a space through which air is introduced into the cyclone body 511, such that a force for sucking air may be increased even by an output of the same suction motor 140.

The air discharge part 514 may be coupled to the cyclone coupling part 530, and at least a part of the air discharge part 514 may be accommodated in an inner peripheral surface of the cyclone body 511.

Specifically, the air discharge part 514 may be formed in a cylindrical shape. In this case, an upper side of the air discharge part 514 based on the longitudinal direction may be coupled to the cyclone coupling part 530 and communicate with the air suction port 146, and a lower side of the air discharge part 514 based on the longitudinal direction may be accommodated in the cyclone body 511.

Therefore, the air, which spirally flows in the cyclone body 511, may flow upward along the air discharge part 514 and flow toward the suction motor 140.

The vane 515 may be disposed between an inner peripheral surface of the cyclone body 511 and an outer peripheral surface of the air discharge part 514 and guide a flow of air.

In this case, the vane 515 may protrude from the inner peripheral surface of the cyclone body 511 or protrude from the outer peripheral surface of the air discharge part 514.

The vane 515 may be formed to become gradually distant from the suction motor 140 in the direction in which the air introduced through the slit 512 flows.

At least one vane 515 may be formed in the circumferential direction of the cyclone body 511. For example, four vanes 515 may be formed at predetermined intervals in the circumferential direction of the cyclone body 511.

In this case, the vane 515 may be formed to be inclined downward in the flow direction of the air. For example, as illustrated in FIG. 6, in case that the air introduced through the slit 512 flows counterclockwise when the cyclone unit 510 is viewed from above, the vane 515 may be formed to be inclined downward counterclockwise.

With this configuration, the air introduced through the slit 512 may flow downward while flowing along the vane 515, and the spiral flow induced by the slit 512 may more strongly and spirally flow while flowing along the vane 515. That is, an angular velocity of the air may be increased by the vane 515, such that a centrifugal force of the air may be increased.

Therefore, the cyclone unit 510 according to the embodiment of the present disclosure may include the slit 512 and the vane 515 to induce a spiral flow of air and further increase a rotational force, such that a centrifugal force may be increased, and performance in separating dust may be improved.

The dust collecting guide part 520 may be disposed between the cyclone unit 510 and the bottom surface of the dust bin 170 and guide a movement of dust separated by the cyclone unit 510.

The dust collecting guide part 520 may be shaped to collect fine dust falling while passing through the cyclone unit 510. Specifically, the dust collecting guide part 520 may be formed in a shape in which a diameter of an upper side is large, and a diameter of a lower side is small. An inner peripheral surface of the dust collecting guide part 520 may be formed to have a curved surface. For example, the dust collecting guide part 520 may be formed in a funnel or horn shape.

With this configuration, the dust collecting guide part 520 may collect the dust, which has passed through the cyclone unit 510, in a lower side of the dust bin 170.

The cyclone coupling part 530 may couple the dust separating part 500 to the main body housing 110.

The cyclone coupling part 530 may be disposed between the cyclone unit 510 and the suction motor 140 and couple the cyclone unit 510 to the main body housing 110. For example, the cyclone coupling part 530 may be formed in a circular plate shape having a predetermined thickness, define a flow path below the suction motor 140, and support the cyclone unit 510. In addition, the mesh net 540 may be coupled to the cyclone coupling part 530.

The cyclone coupling part 530 may be coupled to the air discharge part 514 and connect an internal space of the cleaner main body 100 and an internal space of the cyclone unit 510.

Therefore, the air, from which dust is separated by the cyclone unit 510, may flow to the suction motor 140.

The mesh net 540 may be disposed to surround an outer periphery of the cyclone unit 510. For example, the mesh net 540 may be formed in a cylindrical shape and accommodate the cyclone unit 510 therein.

A plurality of holes may be formed in the mesh net 540. With this configuration, the mesh net 540 may filter out dust with a relatively large size from the air introduced into the dust bin 170. Therefore, the mesh net 540 may prevent dust with a large size from being introduced into the dust separating part 500.

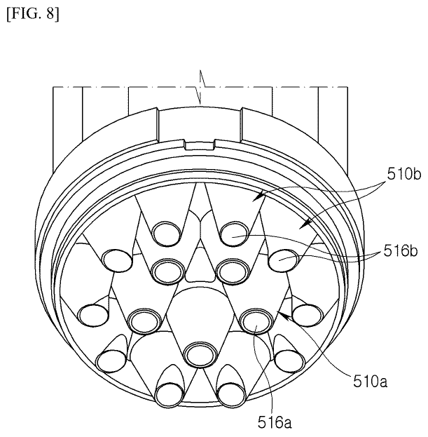

Meanwhile, FIG. 8 is a partial perspective view for explaining a lower arrangement of the plurality of cyclone units of the cleaner according to the embodiment of the present disclosure.

Meanwhile, as illustrated in FIGS. 7 and 8, the dust separating part 500 according to the embodiment of the present disclosure may include the plurality of cyclone units 510. Specifically, the plurality of cyclone units 510 may be disposed in the circumferential direction about an imaginary line defined by extending a rotation axis of the suction motor 140.

In this case, the plurality of cyclone units 510 may be disposed on at least two or more concentric circles having different radii based on an imaginary centerline that penetrates the dust separating part 500. For example, the imaginary centerline of the dust separating part 500 may be disposed at a position coaxial with or parallel to an extension line of a rotation axis of the impeller 141 of the suction motor 140.

For example, the plurality of cyclone units 510 may include inner cyclone units 510a disposed on a concentric circle with a relatively small radius based on the centerline of the dust separating part 500, and outer cyclone units 510b disposed on a concentric circle with a relatively large radius.

For example, an outer peripheral surface of the inner cyclone unit 510a and an outer peripheral surface of the outer cyclone unit 510b may be disposed to be spaced apart from each other. With this configuration, the plurality of slits 512 may be formed in the cyclone units 510, such that the force for sucking air may be increased.

As another example, the outer peripheral surface of the inner cyclone unit 510a and the outer peripheral surface of the outer cyclone unit 510b may adjoin each other. With this configuration, an overall diameter of the dust separating part 500 may be reduced, and a storage capacity of the dust bin 170 may be increased.

Meanwhile, according to the embodiment, the number of slits 512 formed in the inner cyclone unit 510a and the number of slits 512 formed in the outer cyclone unit 510b may be different from each other. For example, two slits 512 may be formed in the inner cyclone unit 510a, whereas three slits 512 may be formed in the outer cyclone unit 510b.

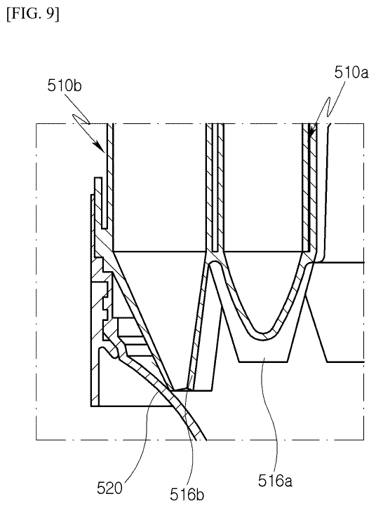

Meanwhile, FIG. 9 is a cross-sectional view for explaining a lower structure of the cyclone unit of the cleaner according to the embodiment of the present disclosure.

The lower structure of the dust separating part 500 of the present disclosure will be described below with reference to FIGS. 8 and 9.

As illustrated in FIGS. 8 and 9, the dust separating part 500 includes the dust discharge part 516. The dust discharge part 516 extends from a lower end of the cyclone body 511 based on the longitudinal direction and discharges dust separated from air.

The dust discharge part 516 may be formed in a shape having a diameter that gradually decreases from the lower end of the cyclone body 511 based on the longitudinal direction.

For example, the dust discharge part 516 may be formed in a hollow truncated conical shape (truncated cone shape) and connected to the lower end of the cyclone body 511 based on the longitudinal direction.

Therefore, the internal space of the dust discharge part 516 and the internal space of the cyclone body 511 may communicate with each other.

With this configuration, dust in the air spirally flowing in the cyclone body 511 may fall into the dust discharge part 516, and relatively clean air, from which dust is separated, may be raised to the air discharge part 514 and discharged.

The dust having passed through the dust discharge part 516 may pass through the dust collecting guide part 520 and be collected in the lower side of the dust bin 170.

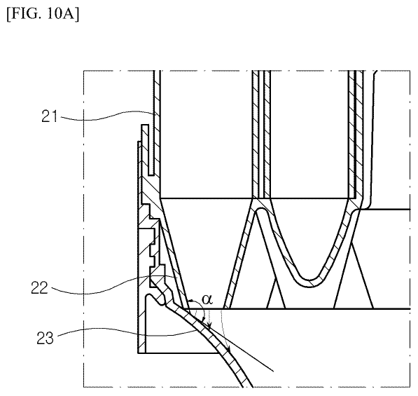

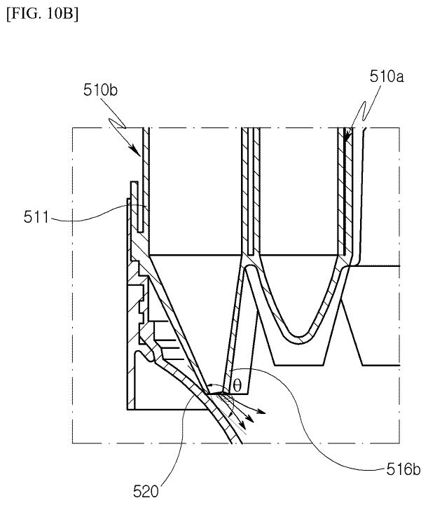

Meanwhile, FIG. 10A is a view for explaining a situation in which a rotational airflow is eliminated as air flowing in the cyclone unit of the cleaner in the related art rubs against a wall surface of the dust bin, and FIG. 10B is a view for explaining an effect of maintaining a rotational airflow of air in the cyclone unit according to the embodiment of the present disclosure.

As illustrated in FIG. 10A, a plurality of cyclone units identical in shape to a cyclone unit of a cleaner in the related art is disposed.

In this case, the cyclone unit, which is disposed to be distant from the center of the dust separating part, may be in contact with or disposed to be very close to the inner peripheral surface of the dust collecting guide part configured to collect fine dust. As a result, there may occur a problem in that an angle a between the inner peripheral surface of the dust discharge part, which guides a discharge of dust, and the inner peripheral surface of the dust collecting guide part is small. For example, the angle a between the inner peripheral surface of the dust discharge part and the inner peripheral surface of the dust collecting guide part may be less than 150 degrees.

Because of this angle, the dust, which is discharged to the dust collecting guide part while flowing along the inside of the cyclone unit, may collide with the inner peripheral surface of the dust collecting guide part, such that a vortex is generated, and the dust is mixed with the air again.

Because the dust separating part is disposed relatively radially inward, there is a limitation in that the dust separation ability deteriorates in comparison with the dust that stably falls without being affected by the dust collecting guide part.

When the plurality of cyclone units 510 of the present disclosure is disposed to be distant from the central line of the dust separating part 500, an overall length may be increased.

Specifically, an overall length of the inner cyclone unit 510a may be longer than an overall length of the outer cyclone unit 510b.

With this configuration, the time for which the air spirally flows in the cyclone unit 510 may be maximally increased, and the ability to separate fine dust from air may be maximized.

In addition, a length of a generating line on the outer peripheral surface of the dust discharge part 516 of the present disclosure may vary. For example, the length of generating line may increase as the dust discharge part 516 is disposed radially outward of the dust separating part 500.

That is, as illustrated in FIG. 9, an inclination defined on the outer peripheral surface of the dust discharge part 516 with a truncated conical shape may have a predetermined angle with respect to the bottom surface of the dust bin 170. In this case, the length of the generating line may increase as the dust separating part 500 is disposed radially outward.

With this configuration, a center of the flow path formed in the dust discharge part 516b of the outer cyclone unit 510b may be eccentrically disposed. That is, a center of the discharge port, through which dust is discharged by the dust discharge part 516b of the outer cyclone unit 510b, may be disposed to be closer to the centerline of the dust separating part 500 than the center of the cyclone body 511.

In addition, a lower end of the inner peripheral surface of the dust discharge part 516b of the outer cyclone unit 510b may be formed to be inclined at a predetermined angle. In this case, the inner peripheral surface of the dust discharge part 516b may be formed in a direction away from the inner peripheral surface of the dust collecting guide part 520. With this configuration, the lower end of the dust discharge part 516b may allow the direction of the discharge port, through which air and dust are discharged, to be formed radially inward of the dust separating part 500.

Therefore, according to the present disclosure, an angle @ defined by the inner peripheral surface of the dust discharge part 516 and the inner peripheral surface of the dust collecting guide part 520 may be increased. For example, the angle O, which is defined by the imaginary extension line of the portion of the inner peripheral surface of the dust discharge part 516, which is disposed to be closest to the dust collecting guide part 520, and the portion of the inner peripheral surface of the dust collecting guide part 520, which is disposed to be closest to the dust discharge part 516, may be 150 degrees or more. That is, the angle defined by the inner peripheral surface of the dust discharge part 516, which is disposed in the flow direction of the dust, and the inner peripheral surface of the dust collecting guide part 520 may be 150 degrees or more (FIG. 10B).

With this configuration, as illustrated in FIG. 10B, it is possible to prevent the situation in which the dust flowing along the inner peripheral surface of the dust discharge part 516 passes through the dust discharge part 516, collides with the inner peripheral surface of the dust collecting guide part 520, and is mixed with air again. Further, the air may be discharged while the spiral flow is maintained.

That is, in the present disclosure, the conical structure formed at the lower side of the cyclone unit 510 is formed to be inclined toward the radially inside of the dust bin 170, which may prevent the rotational airflow generated in the cyclone unit 510 from being eliminated while colliding with the dust collecting guide part 520.

In addition, because the length of the generating line of the dust discharge part 516 increases, a distance, by which air spirally flows in the cyclone unit 510, may be increased, such that the time for which dust is separated may be increased. As a result, the dust separation performance may be improved.

That is, in the present disclosure, the diameter of the dust discharge part 516 at the lower side of the cyclone unit 510 may be decreased, and the length of the cone (the length of the dust discharge part 516) may be increased, such that the length of the inside of the cyclone unit 510 in which air flows may be maximized, thereby improving the dust separation performance.

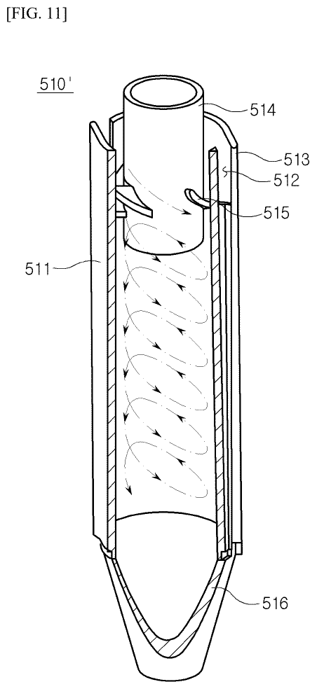

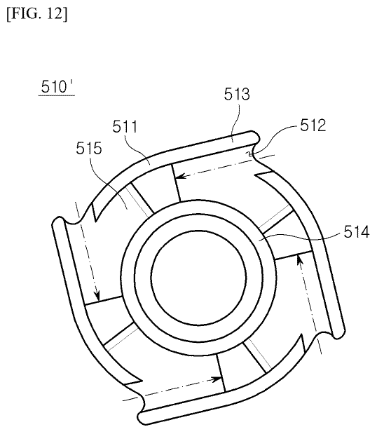

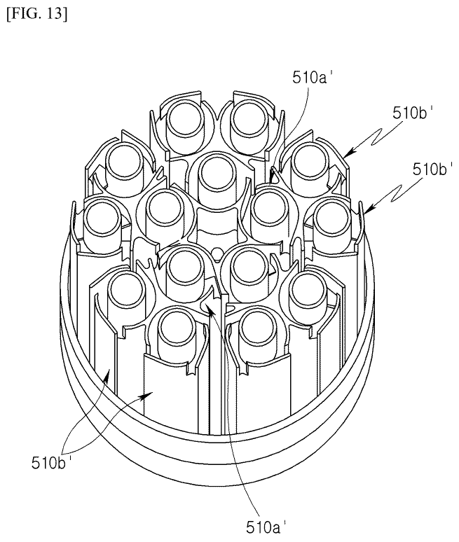

Meanwhile, FIG. 11 is a partially cut-away view for explaining a cyclone unit of a cleaner according to another embodiment of the present disclosure, FIG. 12 is a view illustrating an upper portion of the cyclone unit of the cleaner according to another embodiment of the present disclosure, and FIG. 13 is a view for explaining a state in which a plurality of cyclone units is disposed in the cleaner according to another embodiment of the present disclosure.

In order to avoid the repeated description, the description of the configuration and effect of the cleaner according to the embodiment of the present disclosure may be applied except for components described in the present embodiment.

A cyclone unit 510′according to the present embodiment may further include an air inflow guide 513.

The air inflow guide 513 may guide the air so that the air is introduced into the cyclone body 511.

The air inflow guide 513 may extend radially outward from the cyclone body 511. For example, the air inflow guide 513 may have a shape in which a portion cut out from the cylindrical cyclone body 511 is spread outward in the radial direction of the cyclone body 511.

That is, the air inflow guide 513 may be formed to define a part of a sidewall of the slit 512 formed in the cyclone body 511. In this case, the direction in which the air inflow guide 513 extends from the outer peripheral surface of the cyclone body 511 may be a direction parallel to a direction in which the slit 512 is formed.

Therefore, the air inflow guide 513 may be formed to define an inclined surface with a predetermined angle with respect to the outer peripheral surface of the cyclone body 511. For example, the air inflow guide 513 may be formed in the tangential direction of the cyclone body 511.

The air inflow guides 513 may correspond in number and position to the slits 512. Therefore, at least one air inflow guide 513 may be formed in the circumferential direction of the cyclone body 511. For example, four air inflow guides 513 may be formed at intervals of 90 degrees in the circumferential direction of the cyclone body 511. As another example, three air inflow guides 513 may be formed at intervals of 120 degrees in the circumferential direction of the cyclone body 511. As still another example, three air inflow guides 513 may be formed at intervals of 90 degrees in the circumferential direction of the cyclone body 511. As yet another example, two air inflow guides 513 may be formed at an interval of 180 degrees in the circumferential direction of the cyclone body 511.

The air inflow guide 513 may serve to change a width of the flow path passing through the slit 512 in relation to the slit 512.

That is, a space between the slit 512 and the outer end of the air inflow guide 513 based on the radial direction may be an inlet of the flow path through which the air is introduced into the cyclone body 511. In addition, a space in which the slit 512 and the inside of the cyclone body 511 communicate with each other may be an outlet of the flow path through which the air is introduced into the cyclone body 511. In this case, the inlet of the flow path may be formed in a shape larger in width than the outlet of the flow path.

Therefore, a flow rate of air introduced into the slit 512 may be increased by the inlet of the flow path expanded by the air inflow guide 513. Therefore, the air inflow guide 513 may increase the flow rate of the air introduced into the slit 512.

In addition, because the width of the flow path gradually decreases, a flow velocity of the air flowing along the air inflow guide 513 may increase. Therefore, the flow velocity of the air increases while the air passes through the slit 512, and the air with the increased rotational force may improve the dust separation performance.

Meanwhile, according to the embodiment, the number of air inflow guides 513 formed in an inner cyclone unit 510a′ and the number of air inflow guides 513 formed in an outer cyclone unit 510b′ may be different from each other. For example, two air inflow guides 513 may be formed in the inner cyclone unit 510a', whereas three air inflow guides 513 may be formed in the outer cyclone unit 510b'.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

1. A cleaner comprising:
a suction part having a flow path through which air flows;
a dust separating part configured to separate dust from air sucked through the suction part; and
a suction motor configured to provide a flow force to the air, wherein the dust separating part comprises at least one cyclone unit configured to separate dust from air by means of a cyclone flow, wherein the cyclone unit comprises:
a cyclone body having a cylindrical shape and configured such that air flows in the cyclone body;
an air discharge part configured to allow the air, which has passed through the cyclone body, to flow to the suction motor; and
a vane disposed between an inner peripheral surface of the cyclone body and an outer peripheral surface of the air discharge part and configured to guide a flow of air, and
wherein a slit into which air is introduced is formed in an outer peripheral surface of the cyclone body.

2. The cleaner of claim 1, wherein the slit is formed in a direction that intersects a radial direction of the cyclone body.

3. The cleaner of claim 1, wherein the cyclone unit further comprises an air inflow guide extending radially outward from the cyclone body and formed in a direction applied to a direction in which the slit is formed.

4. The cleaner of claim 2, wherein the vane is formed to become gradually distant from the suction motor in a direction in which air introduced into the slit flows.

5. The cleaner of claim 1, wherein the cyclone unit further comprises a dust discharge part extending from one end of the cyclone body based on a longitudinal direction and configured such that dust separated from air is discharged through the dust discharge part,
wherein the dust discharge part has a diameter that gradually decreases from one end of the cyclone body based on the longitudinal direction, and
wherein a length of a generating line on an outer peripheral surface of the dust discharge part varies.

6. A cleaner comprising:
a suction part having a flow path through which air flows;
a dust separating part configured to separate dust from air introduced through the suction part; and
a suction motor configured to provide a flow force to the air,
wherein the dust separating part comprises at least one cyclone unit configured to separate dust from air by means of a cyclone flow,
wherein the cyclone unit comprises:
a cyclone body having a cylindrical shape and configured such that air flows in the cyclone body; and
a dust discharge part extending from one end of the cyclone body based on a longitudinal direction and configured such that dust separated from air is discharged through the dust discharge part,
wherein the dust discharge part has a diameter that gradually decreases from one end of the cyclone body based on the longitudinal direction, and
wherein a length of a generating line on an outer peripheral surface of the dust discharge part varies.

7. The cleaner of claim 6, further comprising:
a dust bin configured to accommodate the dust separating part therein and store dust separated by the dust separating part,
wherein a length of the generating line of the dust discharge part increases as the dust discharge part becomes distant from a center of the dust bin.

8. The cleaner of claim 6, wherein the dust separating part has a plurality of cyclone units disposed in a circumferential direction about an imaginary line defined by extending a rotation axis of the suction motor.

9. The cleaner of claim 8, wherein the plurality of cyclone units are disposed on at least two or more concentric circles having different radii from a center of the dust separating part, and
wherein an overall length of the cyclone unit increases as the cyclone unit is disposed to be distant from the center of the dust separating part.

10. The cleaner of claim 6, further comprising:
a dust bin configured to store dust separated by the dust separating part,
wherein the dust separating part further comprises a dust collecting guide part disposed between the cyclone unit and a bottom surface of the dust bin and configured to guide a movement of dust separated by the cyclone unit,
wherein the dust flows along the dust discharge part and then flows along the dust collecting guide part, and
wherein an angle defined by an inner peripheral surface of the dust collecting guide part and an inner peripheral surface of the dust discharge part disposed in a flow direction of dust is 150 degrees or more.
